(19) United States
(12) Patent Application Publication
(10) Pub. No.: US 2025/0218657 A1
(43) Pub. Date: Jul. 3, 2025

(54) MANUFACTURING METHOD OF COIL UNIT

(71) Applicant: ASTER CO., LTD., Akita (JP)

(72) Inventor: Takenobu HONGO, Fukushima (JP)

(21) Appl. No.: 18/846,507

(22) PCT Filed: Feb. 3, 2023
(86) PCT No.: PCT/JP2023/003624

§ 371 Date: Sep. 12, 2024

(30) Foreign Application Priority Data
Mar. 30, 2022 (JP) 2022-054913

(51) Int. Cl. H01F 41/06; B21F 3/02

(52) U.S. Cl. CPC H01F 41/06; B21F 3/02

(57) ABSTRACT

A manufacturing method of a coil unit includes a step of winding a conductor to form a coil coupled body constituted of a coupling portion and a plurality of coils that have been coupled through the coupling portion, and a deforming step of deforming so that at least one coil, out of the plurality of coils, moves relative to the other coils.

### CROSS REFERENCE TO RELATED APPLICATIONS

This application is a 371 U.S. National Phase of International Application No. PCT/JP2023/003624, filed on Feb. 3, 2023, which claims priority to Japanese Patent Application No. 2022-054913, filed Mar. 30, 2022. The entire disclosures of the above applications are incorporated herein by reference.

### BACKGROUND

### Technical Field

The present invention relates to a manufacturing method of a coil unit.

### Related Art

Conventionally, as a manufacturing method of coils suitable for use in a motor, there is known a method of connecting a plurality of coils to each other through a connection member after the coils are attached to a stator. See, for example, Japanese Patent Application Laid-Open No. 2009-89456.

However, in the conventional connecting method, the coils are arranged side by side in an annular pattern and afterwards the end portions of the coils that protrude upward are connected to an annular bus bar. As a result, the connecting method is limited to welding, screwing, or the like, and the configuration of connected portions becomes complicated, resulting in a limitation on the miniaturization of completed stators. There are also problems that the size of apparatuses for connection becomes larger and the task of connecting works becomes complicated.

Moreover, although motors used in, for example, electric vehicles are required to have high output and high performance, high productivity (mass production speed) may be desired more than the high output and high performance depending on the application of the motors.

In view of these problems, an object of the present invention is to provide, with regards to a coil unit suitable for use in a motor, a manufacturing method of a coil unit capable of improving productivity.

### SUMMARY

The present invention relates to a manufacturing method of a coil unit, including: a step of winding a conductor to form a coil coupled body constituted of a coupling portion and a plurality of coils that have been coupled through the coupling portion; and a deforming step of deforming so that at least one coil, out of the plurality of coils, moves relative to the other coils.

### Advantageous Effects of Invention

The object according to the present invention is to provide, with regards to a coil unit suitable for use in a motor, a manufacturing method of a coil unit capable of improving productivity.

### BRIEF DESCRIPTION OF THE DRAWINGS

FIG. 1 is an appearance view of a coil unit according to a present embodiment.

FIG. 2 is a flowchart showing an example of a manufacturing method of a coil unit according to the present embodiment.

FIGS. 3(A)-3(D) include schematic diagrams illustrating a coil according to the present embodiment, in which FIG. 3(A) is an appearance view of a conductor that serves as a material, FIG. 3(B) is a front (plan) view of the coil, FIG. 3(C) is a cross-sectional view of the coil, and FIG. 3(D) is a cross-sectional view of the coil.

FIGS. 4(A) and 4(B) include schematic diagrams showing an example of the manufacturing method of a coil unit according to the present embodiment, in which FIG. 4(A) is a plan view, and FIG. 4(B) is a top view.

FIGS. 5(A)-5(E) include schematic diagrams showing an example of the manufacturing method of a coil unit according to the present embodiment.

FIGS. 6(A) and 6(B) include schematic diagrams showing an example of the manufacturing method of a coil unit according to the present embodiment.

FIGS. 7(A)-7(C) include schematic diagrams showing an example of the manufacturing method of a coil unit according to the present embodiment, in which FIG. 7(A) is a top view, FIG. 7(B) is a plan view, and FIG. 7(C) is a plan view.

FIG. 8 is a schematic plan view showing an application example of the coil unit according to the present embodiment.

### DETAILED DESCRIPTION

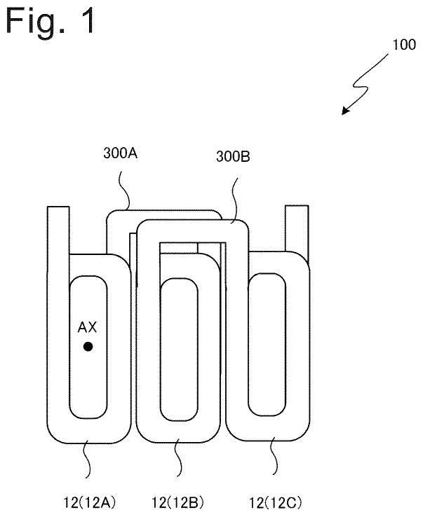

Hereinafter, an embodiment of the present invention will be described in detail with reference to the drawings. In FIG. 1 and subsequent drawings, some of the configurations will be omitted as appropriate to simplify the drawings. In FIG. 1 and subsequent drawings, the size, shape, thickness, etc., of members will be expressed in an exaggerated manner as appropriate.

FIG. 1 is an appearance view showing an example of a coil unit 100 in a present embodiment. Herein, the appearance view is a front view of certain coils 12 constituting the coil unit 100 as viewed from the direction of a virtual axis (helical axis) AX.

The coil unit 100 in the present embodiment is constituted of the plurality of (three in this case) coils 12 (12A to 12C) coupled through a coupling portion 300. Each of the three coils 12 is a so-called concentrated winding coil formed by winding a conductor in a spiral form, for example. For example, the three coils 12 are arranged side by side so that their sides along the longitudinal direction are adjacent to each other, and the adjacent coils 12 are coupled through the coupling portion 300 (300A and 300B). In the coil unit 100, the three coils 12 and the coupling portion 300 are integrally covered with an insulating resin.

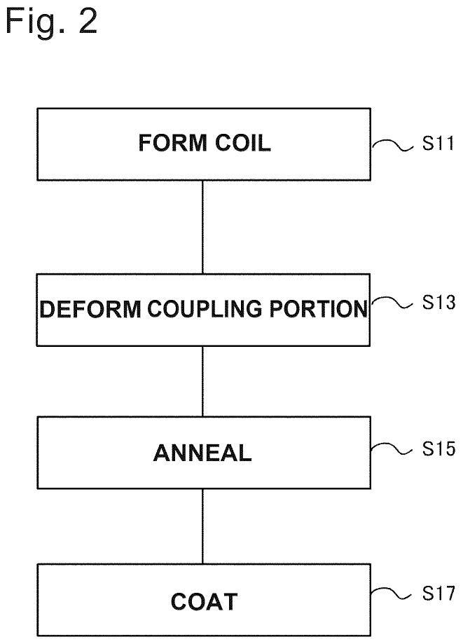

FIG. 2 is a flowchart showing an example of a flow of a manufacturing method of the coil unit 100 according to the present embodiment. The manufacturing method of the coil unit 100 of the present embodiment includes: a coil coupled body forming step of winding a conductor to form the coupling portion 300 and the plurality of coils 12 that have been coupled through the coupling portion 300 (step S11); a step of deforming one coil 12 so that the one coil 12 moves relative to the other coils 12 (step S13); a step of annealing the coil coupled body 102 (step S15); and a step of integrally coating the coil coupled body 102 with a resin material (step S17).

### Coil Coupled Body Forming Step (Step S11)

First, a conductor is wound to form the coil coupled body 102 constituted of the coupling portion 300 and the plurality of coils 12 that have been coupled through the coupling portion 300.

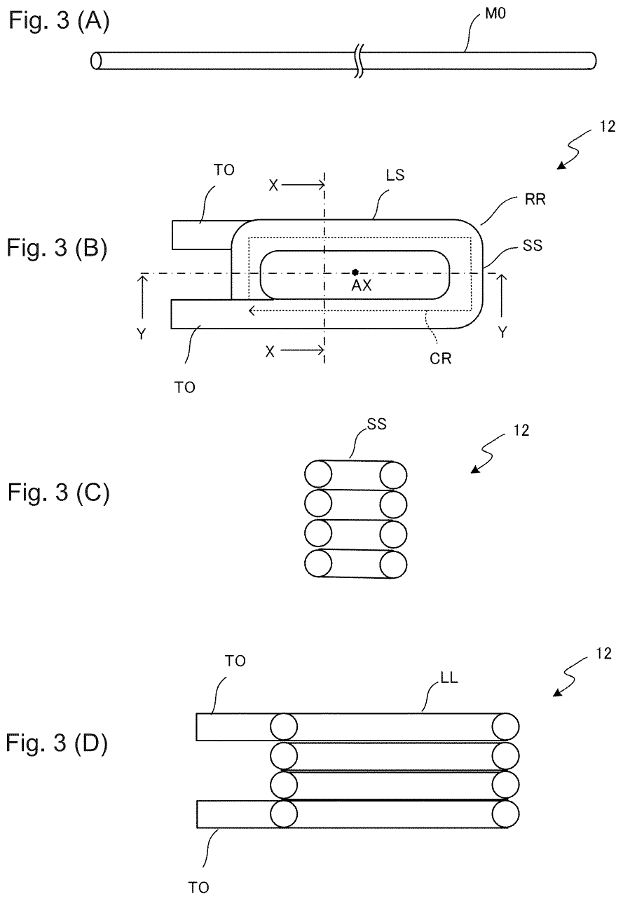

FIGS. 3(A)-3(D) include explanatory views of one coil 12 in the present embodiment, in which FIG. 3(A) is an appearance view of a conductor M0 (metal wire member) that serves as a material, FIG. 3(B) is a front view (plan view) of the coil 12 as viewed from the direction of a virtual axis AX, FIG. 3(C) is a cross-sectional view along line X-X of FIG. 3(B), and FIG. 3(D) is a cross-sectional view along line Y-Y of FIG. 3(B).

As shown in FIG. 3(A), the coil 12 is made of, for example, a long-length conductor M0, specifically a metal wire (round wire conductor) M0, of which the shape of a cross section that intersects (that is orthogonal to) an extending direction (longitudinal direction, helical traveling direction) of the conductor M0 (hereinafter simply referred to as “a cross sectional shape of the conductor”) is a substantially round shape. As an example, the conductor M0 is a metal wire mainly made of aluminum. The metal wire mainly made of aluminum is a metal wire constituted of aluminum or an aluminum alloy and is, for example, a metal line-shaped material containing 50% or more of aluminum or aluminum alloy.

As shown in FIGS. 3(B) to 3(D), the conductor M0 is first wound in a helical shape to form the coil 12. The coil 12 is a so-called concentrated winding coil, which is a helical structure body formed by winding the conductor M0 around a given virtual axis AX and continuously stacking regions corresponding to one turn (hereinafter referred to as “one-turn regions CR”) of the conductor M0 so as to be overlapped in an extending direction of the virtual axis AX. The virtual axis AX is a helical (coil) axis, which is hereinafter referred to as a helical axis AX. A region where a plurality of one-turn regions CR overlap each other and constitute the helical structure is referred to as a winding region of the coil 12.

For example, as shown in FIGS. 3(B) to 3(D), the coil 12 is wound to have a substantially rectangular shape, with shorter sides SS and longer sides LS being present as a region for one turn (one-turn region CR) of the winding (helix). Note that the shape of the coil 12 is not limited to the illustrated shape and may be any shape obtained by winding the conductor M0. In other words, the coil 12 in plan view may have a (substantially) elliptic shape, a (substantially) oval shape, or a substantially round shape. For example, in the case of manufacturing the coil 12 to be attached to a stator as a component of a motor, the coil 12 is preferably wound into a shape that is long in one direction in plan view. Here, as an example, both ends of the coil 12 are positioned outside the helical winding region (region where the one-turn regions CR overlap) as lead-out portions TO.

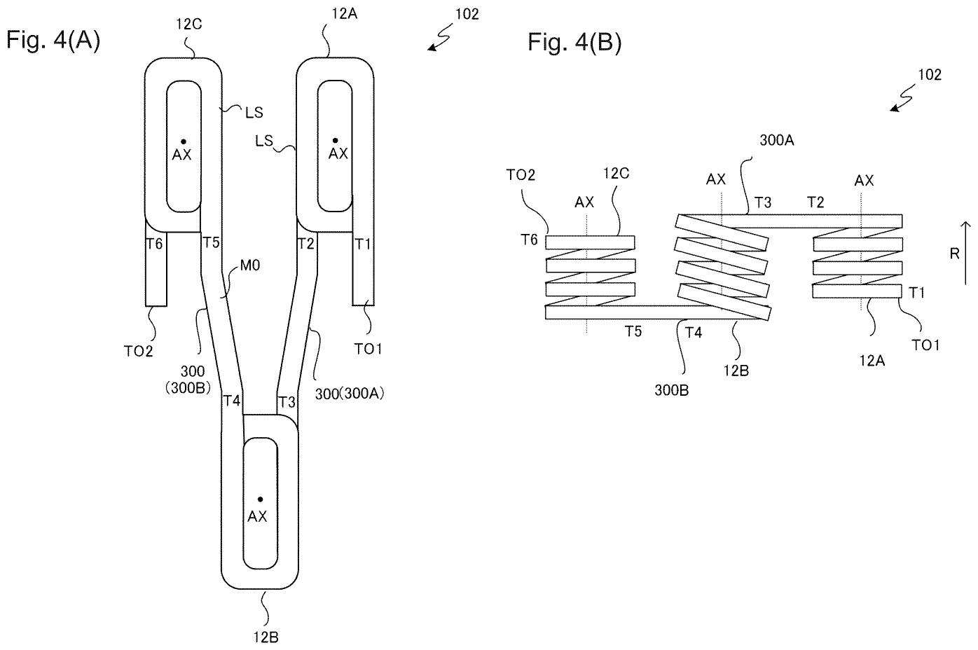

FIGS. 4(A) and 4(B) include appearance views of the coil coupled body 102 (first-shape coil unit) having the plurality of (three in this case) coils 12 coupled through the coupling portion 300, in which FIG. 4(A) is a view (plan view) of the coil coupled body 102 as viewed from the direction of the helical axis AX, and FIG. 4(B) is a schematic view (top view) of the coil coupled body 102 of FIG. 4(A) as viewed from above.

The coil coupled body 102 has a configuration in which three coils 12A to 12C are coupled through the coupling portion 300 in this example. Hereinafter, when it is necessary to distinguish between the three coils 12A to 12C, they are referred to as a first coil 12A, a second coil 12B, and a third coil 12C for the convenience of description.

The coil coupled body 102 is formed from the conductor M0 that is shown in FIG. 3(A). More specifically, the conductor M0 is wound with a desired number of turns to form the first coil 12A. An end portion T1 of the first coil 12A serves as a lead-out portion TO1. Then, a prescribed length of the other end portion T2 of the first coil 12A is secured in a non-winding state, and the second coil 12B is wound continuously to the other end portion T2. An end portion T3 of the second coil 12B is continuous to the end portion T2 of the first coil 12A, and the conductor M0 in the non-winding state between the end portions T2 and T3 serves as the coupling portion 300 (300A). Similarly, a prescribed length of the other end portion T4 of the second coil 12B is secured in the non-winding state, and the third coil 12C is wound continuously to the other end portion T4. An end portion T5 of the third coil 12C is continuous to the end portion T4 of the second coil 12B, and the conductor M0 in the non-winding state between the end portions T4 and T5 serves as the coupling portion 300. The other end portion T6 of the third coil 12C serves as the other lead-out portion TO2.

In this example, the three coils 12A to 12C are arranged in a triangular shape (substantially Y shape) as shown in FIG. 4(A), in terms of an arrangement in plan view, and are coupled to each other through the coupling portion 300. However, the arrangement of the three coils 12A to 12C is not limited to this example as long as the respective coils 12 are coupled through the coupling portion 300 of a prescribed length. For example, it is possible to adopt a configuration where the three coils 12A to 12C are connected to each other via the coupling portion 300 and arranged side by side so that the respective longer sides LS are parallel to each other. In this example, as shown in FIG. 4(B), the three

coils 12A, 12B, and 12C are identical to one another in their helical winding directions (turning directions), for example, all the three coils are wound counterclockwise (left-handed helix) when the helical axis AX is viewed from the R-direction. All the three coils 12A, 12B, and 12C may be wound clockwise (right-handed helix).

In this way, the coil coupled body 102, which is constituted of the coupling portion 300 and the plurality of (three in this case) coils 12A to 12C coupled through the coupling portion 300, is formed. The lead-out portions TO1 and TO2 and the coupling portion 300 are all located outside the helical winding regions of the coils 12A to 12C.

### Deforming Step (Step S13)

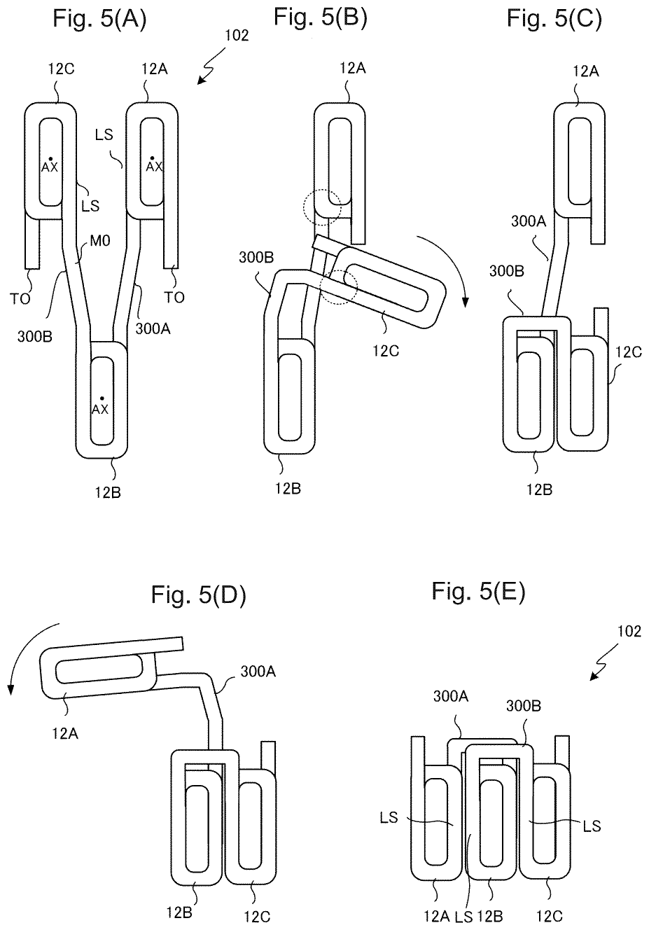

Next, a step (deforming step) of deforming so that at least one coil 12, out of the plurality of coils 12, moves relative to the other coils 12 will be described with reference to FIGS. 5(A)-5(E). FIGS. 5(A)-5(E) include plan views of the coil coupled body 102 as viewed from the direction of the helical axis AX. In the coil coupled body 102, the three coils 12A to 12C are coupled through the coupling portion 300 (300A and 300B) of the conductor M0.

In this step, deformation is made so that at least one coil 12, out of the plurality of coils 12A to 12C, moves relative to the other coils 12. Specifically, the coupling portion 300 is deformed so that at least one coil 12 is moved to a position adjacent (proximate) to the other coils 12. The deformation of the coupling portion 300 is, for example, bending deformation and/or twisting deformation, and may include elongation.

Specifically in this example, as shown in FIG. 5(A), the coupling portion 300 (300A and 300B) has a prescribed length, and the three coils 12A to 12C are arranged at substantially Y-shaped positions so as to be separated from each other. In this step, the coupling portion 300 is deformed (for example, bent in a predetermined direction) to move the three separated coils 12A to 12C to such positions that the respective longer sides LS are adjacent or proximate (side by side) to each other. Here, in the state shown in FIG. 5(A), the three coils 12A to 12C are arranged roughly in the same horizontal plane, for example. More precisely, at least an uppermost or lowermost (outermost or innermost) one-turn region CR of each of the coils 12A to 12C is arranged on a substantially identical plane.

Furthermore, for example, as shown in FIG. 5(B), the coupling portion 300B is bent so that the third coil 12C rotates around the second coil 12B and is thereby adjacent to the right side of the second coil 12B while the extending direction of the helical axis AX is maintained (FIG. 5(C)). In the case where the three coils 12A to 12C are arranged roughly in the same horizontal plane, parts (such as the vicinity of broken line circles) of the third coil 12C and the first coil 12A may interfere with each other during the deformation shown in FIG. 5(B), for example. In such a case, while the third coil 12C is moved so as to rotate around the second coil 12B, twisting deformation is also applied so as to move the third coil 12C in the direction of the helical axis AX.

Furthermore, as shown in FIG. 5(D), the coupling portion 300A is deformed so that the first coil 12A is rotated around the second coil 12B and is thereby adjacent to the left side of the second coil 12B while the extending direction of the helical axis AX is maintained (FIG. 5(E)). Note that the order of deformation of the coupling portion 300 is not limited to the above-mentioned example. For example, the coupling portion 300B may be deformed to move the position of the third coil 12C after the position of the first coil 12A is moved by deforming the coupling portion 300A.

This configuration makes it possible to obtain the coil coupled body 102 with the three coils 12A to 12C being side by side so that the respective longer sides LS are adjacent to each other.

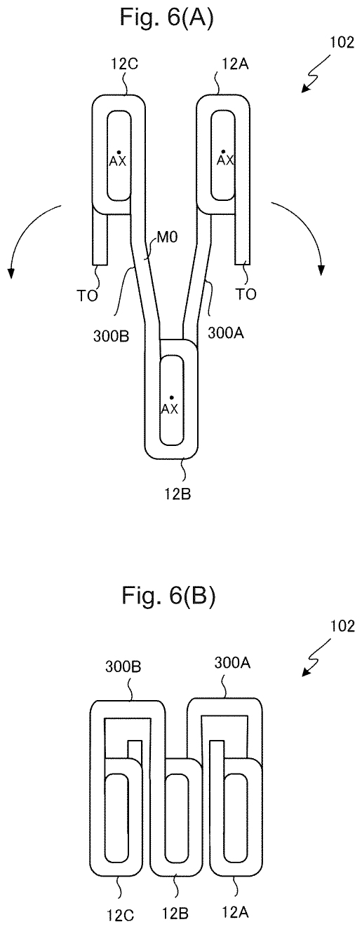

FIGS. 6(A) and 6(A) show another example of deforming the coupling portion 300 from the state shown in FIG. 5(A). As shown in FIGS. 6(A) and 6(B), the coil coupled body 102, with the three coils 12A to 12C being adjacent to each other side by side as shown in FIG. 6(B), may be formed by deforming (bending) the coupling portion 300A so that the first coil 12A is adjacent to the right side of the second coil 12B while the extending direction of the helical axis AX is maintained, and deforming (bending) the coupling portion 300B so that the third coil 12C is adjacent to the left side of the second coil 12B while the extending direction of the helical axis AX is maintained.

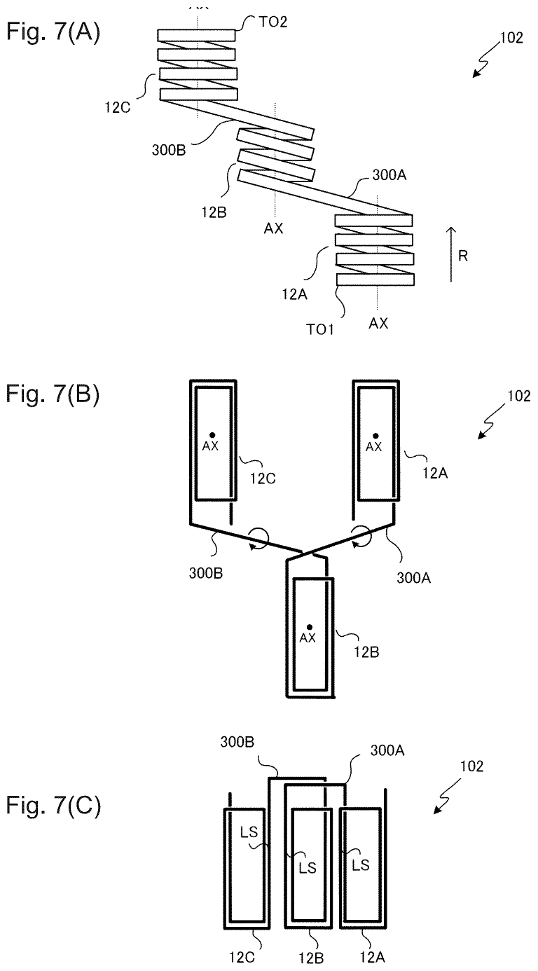

FIGS. 7(A)-7(C) include schematic diagrams showing the coupling state of the coils 12A to 12C and another example of the deformation of the coupling portion 300. FIG. 7(A) is a top view of the coil coupled body 102 corresponding to FIG. 4(B), and FIGS. 7(B) and 7(C) are schematic plan views of the coil coupled body 102 as viewed from the helical axis direction.

In the example shown in FIG. 7(A), when the helical axis AX is viewed from R direction, the three coils 12A to 12C coupled through the coupling portion 300 are different in helical winding direction (turning direction) from each other, that is, their winding directions change so as to be opposite to each other. For example, the first coil 12A is wound clockwise (right-handed helix), the second coil 12B is wound counterclockwise (left-handed helix), and the third coil 12C is wound clockwise (right-handed helix). The coils may be wound in the directions opposite to the directions described above.

In this case, for example, while the coupling portion 300A (conductor M0) is twisted so as to rotate around the axis of the coupling portion 300A as indicated by an arrow in FIG. 7(B), the first coil 12A is moved to the position that is on the right side of the second coil 12B. Moreover, while the coupling portion 300B (conductor M0) is twisted so as to rotate around the axis of the coupling portion 300B, the third coil 12C is moved to the position that is on the left side of the second coil 12B.

This configuration makes it possible to form the coil coupled body 102 with the three coils 12A to 12C being side by side so that the respective longer sides LS are adjacent to each other as shown in FIG. 7(C).

In each of these cases, in the coil coupled body 102 after deformation of the coupling portion 300, the respective coils 12 are arranged side by side so that the longer sides LS of the respective coils 12 are adjacent (proximate) to each other and are coupled through the coupling portion 300 (300A and 300B) at positions not overlapped with the winding regions of the respective coils 12 (above the helical (winding regions) of the respective coils 12 in this example).

Note that the winding method (winding direction) of the three coils 12A to 12C and/or the method of deforming the coupling portion 300 are merely examples, and other winding methods and other deformation may be adopted without being limited to those illustrated above.

The positional relationship among the three coils 12A to 12C after deformation of the coupling portion 300 is not limited to side by side arrangement as shown in FIGS. 1, 5(E), 6(B), 7(C), and the like. The distance between the coils 12A to 12C may be larger than the illustrated distance, and instead of the side-by-side arrangement, any arrangement may be selected, such as an arrangement in which the longer sides LS of one coil 12 are inclined with respect to the longer sides LS of the other coils.

### Annealing Step (Step S15)

Next, the coil coupled body 102 is annealed and deformed into a desired shape as necessary. This deformation is, for example, a deformation for a coating step to be performed later, and involves separating each turn of the one-turn regions CR and/or separating the coupling portions 300A and 300B in each of the coils 12A to 12C, to such an extent that each turn or each coupling portion can be applied (coated) with a resin. It is also possible to deform the lead-out portion TO (TO1 and TO2) to allow connection with a desired terminal, for example.

In addition to the annealing step after the bending step of the coupling portion 300, the annealing step may be performed before the bending step or, instead of the annealing step after the bending step of the coupling portion 300, the annealing step before the bending step may be performed.

### Coating Step (Step S17)

Next, the surface of the conductor M0 of the coil coupled body 102 is coated with an insulating resin. As a result, the coil unit 100 (second-shape coil unit) as shown in FIG. 1 is formed. Coating with the insulating resin is performed by electrodeposition coating, for example. Each helical turn of the coils 12A to 12C is separated by molding after annealing, this separation allowing sufficient contact (of the surface of one long-length conductor) with a paint solution throughout the entire helical structure.

In the coil unit 100, the three coils 12 are integrally covered with an insulating resin, for example. In the coil unit 100, the helix of each coil 12 is unfolded to be one conductor, and the insulating resin covers the surface of the one conductor. In other words, in winding region portions of the respective coils 12, the respective one-turn regions CR are insulated, by the insulating resin, from other one-turn regions CR.

Here, coating with an insulating resin may be performed by spraying insulating resin materials or injection molding of the insulating resin.

In the present embodiment, a configuration in which the three coils 12A to 12C are coupled has been illustrated. However, the number of the coils 12 to be connected is not limited to this example. For example, a configuration may be adopted in which five coils 12 are coupled through the coupling portion 300.

Although illustration is omitted, an external connection member is connected to at least one of the lead-out portions TO1 and TO2 of the coil unit 100 (or the coil coupled body 102) as necessary. The external connection member is a terminal or a bus bar, for example. The external connection member can be connected to the lead-out portion TO1 and TO2 by pressure-welding (cold pressure-welding), in which both end faces are butted and pressed. This connection may be achieved by, for example, welding, or bonding using a conductive adhesive. The external connection member may be a metal material (e.g., a metal material mainly made of aluminum) same as the conductor M0 (e.g., a metal material mainly made of aluminum), or may be a metal material (e.g., a metal material mainly made of copper (such as copper or a copper alloy)) different from the conductor M0. For example, sufficiently long lead-out portions TO1 and TO2 may be secured and deformed into desired shapes in the bending step of the coupling portion 300, and the resultant portions may be used as the external connection member (e.g., a bus bar). As a result, it becomes possible to form a bus bar-welded coil unit 100 without separately connecting the external connection member.

In the case of connecting the external connection member to the lead-out portions TO1 and TO2 at a later stage, the connecting operation may be performed, for example, before coating with an insulating resin. Alternatively, after coating with the insulating resin, the insulating resin on the lead-out portions TO1 and TO2 may be removed for the connecting operation.

### <Stator Member>

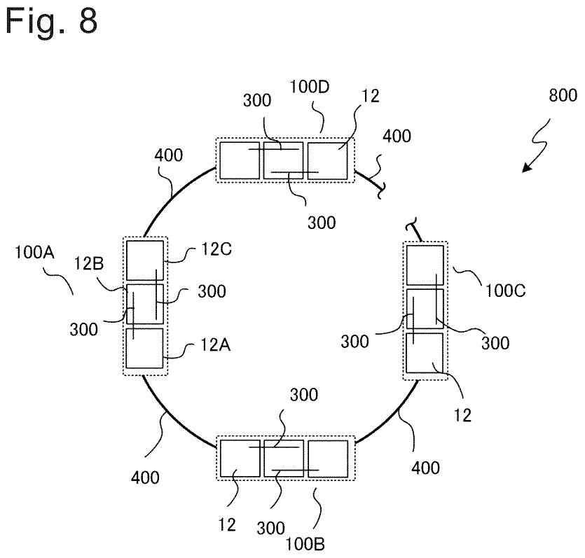

FIG. 8 is a schematic plan view showing an example of a stator member 800 configured by continuously joining the plurality of (four in this case) coil units 100 described above.

The four coil units 100 (100A to 100D) are coupled through a connection portion (bus bar) 400. The connection portion 400 can be constituted of conductors that are continuous to the four coil units 100, for example. Each coil unit 100 is similar to the one shown, for example, in FIG. 1. Specifically, one conductor M0 is wound to form, for example, four coil units 100 each constituted of three coils. The coil units 100 are each wound in such a way that the three coils 12 are continuously joined through the coupling portion 300 having a prescribed length and are configured so that the three coils 12 are adjacent to each other due to the deformation of the coupling portion 300. In addition, the four coil units 100 are each wound so as to be continuous via the connection portion (bus bar) 400 having a prescribed length.

As a result, the stator member 800, with four coil units 100 (100A to 100D) being coupled through the connection portion (bus bar) 400 as shown in FIG. 8, is formed. In this case, the connection portion 400 is made of the same material as the coil units 100, for example.

Alternatively, the stator member 800 may be formed by connecting the four coil coupled bodies 102 and the connection portion 400 serving as the external connection member by pressure-welding or the like. In this case, the connection portion 400 (external connection member) is connected to the lead-out portion TO of each of the four coil units 100 (100A to 100D). In this case, the connection portion 400 may be made of the same material as the coil unit 100 or made of a different material (e.g., copper).

In the case of forming such a stator member 800, the step of coating with an insulating resin may be performed after the plurality of continuous coil coupled bodies 102 are formed (after the plurality of coil coupled bodies 102 are connected) (Step S17).

The plurality of stator members 800 are additionally formed and attached to an annular stator core (not shown), and thereby a stator with the plurality of coils 12 arranged in an annular pattern is formed. For example, when the three coils 12A to 12C constituting one coil unit 100 (or each of the coil units 100) are made to have current or voltage phase different from each other, such as U phase, V phase, and W phase, the stator member 800 for a three-phase motor can be manufactured.

Note that the stator member 800 shown in FIG. 8 is adopted for a radial gap type motor in which the direction of the helical axis AX of the coil 12 is orthogonal to the axial direction of the motor. However, without being limited thereto, the manufacturing method of the coil unit 100 of the present embodiment makes it possible to form a stator member that is adopted for an axial gap type motor in which the direction of the helical axis AX of the coil 12 is parallel to the axis direction of the motor, by appropriately changing the shape (winding method or arrangement) of the coil coupled body 102 and the mode of deformation of the coupling portion 300.

As described above, in the present embodiment, the case where the conductor M0 is a conductor having a substantially round shape in cross section has been described as an example. However, the shape of the conductor M0 is not limited to this example. For example, the conductor M0 may be a flat round wire having an elliptic (oval) shape in cross section, may be a round corner square wire or a round corner flat square wire having a substantially rectangular shape with round corners in cross section, or may be a square wire or a flat square wire having a substantially rectangular shape (polygonal shape) in cross section.

Thus, according to the present embodiment, the coil 12 suitable for use in a motor component can be manufactured by simple apparatuses and steps without the need for complicated steps and apparatuses, making it possible to reduce manufacturing costs and to improve productivity (mass production speed).

Again, the conductor (e.g., the conductor M0) in the present embodiment is, for example, a metal material having copper as a main component or a metal material having aluminum as a main component. The conductor may be constituted of a plurality of metal materials connected in the longitudinal direction, for example, the end face of a metal material having copper as a main component and the end face of a metal material having aluminum as a main component are pressed and continuously joined to each other (and this operation is repeated once or a plurality of times) to form one conductor. In other words, the metal material of the coil 12 may be changed in the middle of winding. The plurality of coils that constitute the coil unit 100 may also be constituted of different metal materials.

Furthermore, in the above-described embodiment, the case where the coil 12 is a concentrated winding coil obtained by winding a conductor in a helical form has been illustrated. However, without being limited to this case, the coil 12 may be a so-called distributed winding coil or wave winding coil, obtained by winding the conductor so that the winding region (one-turn region CR) around the virtual axis is shifted in one direction (for example, a circumferential direction of the stator).

Note that the present invention is not limited to the above-described embodiments, and it goes without saying that various modifications can be made without departing from the gist of the present invention.

1. A manufacturing method of a coil unit, comprising:
a step of winding a conductor to form a coil coupled body constituted of a coupling portion and a plurality of coils that have been coupled through the coupling portion; and
a deforming step of deforming so that at least one coil, out of the plurality of coils, moves relative to the other coils.

2. The manufacturing method of a coil unit according to claim 1, wherein the coupling portion is deformed in the deforming step so that one coil is adjacent to the other coils.

3. The manufacturing method of a coil unit according to claim 1, wherein annealing is performed on the coil coupled body after the deforming step.

4. The manufacturing method of a coil unit according to claim 1, wherein the coil coupled body is coated with a resin after the deforming step.
